(19) United States
(12) Patent Application Publication
(10) Pub. No.: US 2013/0099928 A1
(43) Pub. Date: Apr. 25, 2013

(54) Method and System for Detecting Duress Using Proximity Card

(71) Applicants: Glenn Daly, Nashua, NH (US); Michael Morley, Deerfield, NH (US)

(72) Inventors: Glenn Daly, Nashua, NH (US); Michael Morley, Deerfield, NH (US)

(21) Appl. No.: 13/276,652

(22) Filed: Oct. 19, 2011

(51) Int. Cl. G08B 23/00

(52) U.S. Cl. 340/573.1

(57) ABSTRACT

The system and method for detecting duress using a proximity card comprising at least one transponder and a switch. The switch configured to activate with the user's touch. The switch comprising a thermistor, a piezoelectric sensor, an exposed electrode, a capacitive sensor, or the like, which is located on the proximity card. The switch is configured to modify the signal form a first transponder, or activate a second transponder, thereby sending a duress signal. If a duress pattern is recognized, then the system notifies another party of the situation, or sets a system flag.

### FIELD OF THE INVENTION

The present invention relates to physical security and access control and more particularly to detecting if a person gaining access using a proximity card is under duress.

### BACKGROUND OF THE INVENTION

If a person attempting to gain access to a secured area is in a situation in which they are under duress from a third party intruder, such as during a robbery, the methods of notifying others are limited. Some of the current conventional methods include a duress PIN, a reverse card, a duress biometric, and a panic button.

In the duress PIN method, to enter a secured area the operator enters a special PIN which silently signals a duress condition, but still permits access to the secured area. For example, one could enter the same PIN as under normal conditions, but end the sequence with an asterisk instead of the pound sign to signal duress. Alternatively, there could be a PIN pad on the proximity card that is used when under duress, much like with an external PIN pad. In the reverse card method, to enter a secured area the operator swipes his magnetic stripe card in the opposite direction, which silently signals a duress condition, but still permits access to the secured area. In the duress biometric method, to enter a secured area the operator uses the opposite hand, finger, or eye which silently signals a duress condition, but still permits access to the secured area. In the panic button method, a panic button is placed either in a fixed or mobile location to which the person experiencing the duress has access.

Unfortunately the first three of these methods are also tied to a specific access technology, that of PIN, magnetic strip card, and biometrics, respectively. Unlike the three previous methods, the panic button method does not have to be associated with a door, but it requires a dedicated device. In addition to the weaknesses of these previous duress methods, they are commonly applied throughout the world, and so they are well-known to criminals who may take steps to prevent the operator from performing such actions. Another fault with these previous duress methods is that none of these methods utilize the most common technology used for access control. The most common technology used for access control is the proximity card and/or a smart card.

These (proximity and smart card) common technologies are currently limited in duress applications. Thus, there is a need for a security system that has the capability to determine if a person using a proximity and/or smart card is under duress while using the card. Ideally, this security system with this capability would be cost-effective, easy to implement, and easy to use without requiring the installation of an entirely new security system, which would raise operating costs for countless industries.

### SUMMARY OF THE INVENTION

Secure buildings rely on access control systems that selectively allow authorized users access between buildings or between areas within a building. In an access control system setting duress can be defined as a user being forced to provide access to an area or resource by a third party. Access control systems rely on a mechanism for users to signal when they are under duress while making an access attempt. Current proximity cards lack the ability to signal duress when used with an access control system. This leaves companies using proximity card technology vulnerable to security violations because of this inability to be notified when an authorized user is under duress. This also leaves users using proximity cards vulnerable to attack by third parties due to the inability to safely signal for help when under duress.

One aspect of the present invention is a duress detection system for assessing if a user seeking access to a secured area or resource is under duress, the system comprising, a proximity card, wherein the proximity card comprises a first transponder and a switch; a card reader configured to receive a duress signal from a transponder; an access control point configured to control access to a secured area; and a notification mechanism capable of notifying a third party that the system has received a duress signal.

In one embodiment of the duress detection system, the proximity card further comprises a second transponder.

In one embodiment of the duress detection system, the switch is configured to be activated by the user's touch. In one embodiment of the duress detection system, the switch is configured to switch between the first transponder and the second transponder. In one embodiment of the duress detection system, the switch is configured to modify the signal from the first transponder to a duress signal. In one embodiment of the duress detection system, the switch comprises a thermistor. In one embodiment of the duress detection system, the switch comprises a piezoelectric sensor. In one embodiment of the duress detection system, the switch comprises an exposed electrode. In one embodiment of the duress detection system, the switch comprises a capacitive sensor.

In one embodiment of the duress detection system, the notification mechanism sends an alarm. In one embodiment of the duress detection system, the notification mechanism sets a system flag. In one embodiment of the duress detection system, the notification mechanism sets the access control point to provide access in response to the duress signal. In one embodiment of the duress detection system, wherein the notification mechanism sets the access control point to deny access in response to the duress signal.

In one embodiment of the duress detection system, the duress signal comprises a reverse bitstream. In one embodiment of the duress detection system, the duress signal comprises a universal duress signal. In one embodiment of the duress detection system, the duress signal comprises a custom duress bit stream. In one embodiment of the duress detection system, the duress signal comprises a duress flag bit.

Another aspect of the present invention is a method of detecting duress comprising, capturing a signal from a proximity card located near an access control point, wherein the proximity card comprises a first transponder and a switch; comparing the signal from the proximity card to information in an access control database; determining if duress is occurring; and notifying a third party that a duress signal has been received.

In one embodiment of the method of detecting duress, the step of notifying a third party comprises sending an alarm. In one embodiment of the method of detecting duress, the step of notifying a third party comprises setting a system flag.

In one embodiment of the method of detecting duress, the method further comprises the step of setting the access control point to provide access in response to the duress signal. In one embodiment of the method of detecting duress, the method further comprises the step of setting the access control point to deny access in response to the duress signal.

In one embodiment of the method of detecting duress, the duress signal from the proximity card comprises a reverse bit stream. In one embodiment of the method of detecting duress, the duress signal from the proximity card comprises a universal duress signal. In one embodiment of the method of detecting duress, the duress signal from the proximity card comprises a custom duress bit stream. In one embodiment of the method of detecting duress, the duress signal from the proximity card comprises a duress flag bit.

In one embodiment of the method of detecting duress, the proximity card further comprises a second transponder. In one embodiment of the method of detecting duress, the duress signal from the proximity card originates from the second transponder.

In one embodiment of the method of detecting duress, the switch is configured to be activated by the user's touch. In one embodiment of the method of detecting duress, the switch comprises a thermistor. In one embodiment of the method of detecting duress, the switch comprises a piezoelectric sensor. In one embodiment of the method of detecting duress, the switch comprises an exposed electrode. In one embodiment of the method of detecting duress, the switch comprises a capacitive sensor.

Another aspect of the present invention is a duress-capable proximity card comprising, a single transponder; an integrated circuit, wherein the integrated circuit is attached to the single transponder thereby creating a circuit capable of transmitting a signal; and a switch connected to the integrated circuit, wherein the switch is configured to modify the signal transmitted by the single transponder, thereby creating a second signal from a single transponder.

In one embodiment of the duress-capable proximity card, the switch is configured to activate upon the user's touch. In one embodiment of the duress-capable proximity card, the switch comprises a thermistor. In one embodiment of the duress-capable proximity card, the switch comprises a piezoelectric sensor. In one embodiment of the duress-capable proximity card, the switch comprises an exposed electrode. In one embodiment of the duress-capable proximity card, the switch comprises a capacitive sensor.

In one embodiment of the duress-capable proximity card, the second signal comprises a reverse bit stream. In one embodiment of the duress-capable proximity card, the second signal comprises a universal distress signal. In one embodiment of the duress-capable proximity card, the second signal comprises a custom duress bit stream. In one embodiment of the duress-capable proximity card, the second signal comprises a duress flag bit.

Another aspect of the present invention is a duress-capable proximity card comprising, a first transponder; an integrated circuit, wherein the integrated circuit is attached to the first transponder thereby creating a first circuit capable of transmitting a first signal; a second transponder adjacent to, but not connected to, the first circuit; and a switch connected to the second transponder thereby creating a second circuit capable of transmitting a second signal.

In one embodiment of the duress-capable proximity card, the switch is configured to activate upon the user's touch. In one embodiment of the duress-capable proximity card, the switch comprises a thermistor. In one embodiment of the duress-capable proximity card, the switch comprises a piezoelectric sensor. In one embodiment of the duress-capable proximity card, the switch comprises an exposed electrode. In one embodiment of the duress-capable proximity card, the switch comprises a capacitive sensor.

In one embodiment of the duress-capable proximity card, the second signal comprises a reverse bit stream. In one embodiment of the duress-capable proximity card, the second signal comprises a universal distress signal. In one embodiment of the duress-capable proximity card, the second signal comprises a custom duress bit stream. In one embodiment of the duress-capable proximity card, the second signal comprises a duress flag bit.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic of a prior art proximity card.

FIGS. 2a and 2b show two embodiments of a proximity card of the present invention.

FIG. 3 shows the system for detecting duress using a proximity card of the present invention.

### DETAILED DESCRIPTION OF THE INVENTION

The system and method of determining duress provides a proximity card capable of emitting either standard or duress bit patterns. The duress bit pattern could be a reverse bit stream or some other identifiable bit stream, such as a unique (to the user) or universal (much like 911) bit pattern sent in lieu of the standard bit pattern. For example, parity could be altered to signal duress, or one or more of the bits could be used as a duress flag bit. The duress signal could also be a custom duress bit stream that could be unique to the user, thus still identifying the user to the system. The system could examine any bits in the pattern to identify duress, i.e. a different site code/company code (number that is usually universal across the physical site) could be substituted for a duress site code. Alternatively, the card number (number than ensures uniqueness from its site code family of cards) may differ, whereby odd card numbers provide the duress identifier.

Ideally, this bit stream will be detected by existing reader technologies without the need to change or replace entire security systems. Once a duress pattern is recognized, the system notifies another party of the situation, such as a security officer. The notification could consist of audible or silent alarms. The system could also set the access control device to either provide or deny access upon receipt of a duress signal.

This proximity card will have non-discrete, non-mechanical contact(s) allowing the user to activate or deactivate one of the circuits by simple placement of a finger(s) on the contact(s). The act of touching the contact(s) will either complete or ground the circuit(s), thus deactivating the standard non-duress signal and enabling the duress signal.

The card may have a second transponder for the creation of the duress signal, but it is not necessary. For example, one could use a single transponder using a switching action to modify the outgoing bit pattern, rather than relying on switching off the primary transponder and switching on the secondary (duress) transponder. One way the proximity card of the present invention utilizes current card technology is by adding a second transponder circuit to the card, instead of requiring the introduction of new technology.

The proximity card can utilize various methods known in the art to 1) switch from the first transponder to the second transponder, signaling duress, or 2) to modify the outgoing bit pattern from a single transponder via a switch, signaling duress. Some switches known by those of ordinary skill in the art include thermistors, exposed electrodes—contacts, capacitive sensors, and piezoelectric sensors. A capacitive sensor could be similar to a laptop touchpad whereby the charge from a single conductor is dispersed into the touching finger, or where the distance between two conductors sandwiching a dielectric material is reduced by pressure, thus changing the capacitive characteristic. The proximity card of the present invention utilizes current card reader technology and does not require the replacement of card readers in order to implement, thus saving companies time and money.

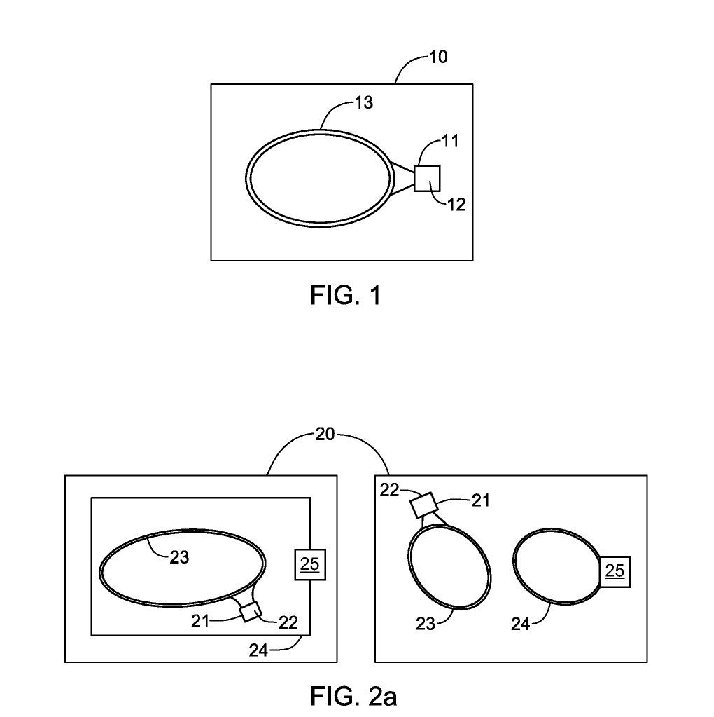

Referring to FIG. 1, the prior art proximity card 10 comprises an integrated circuit 11, a capacitor 12, and a coil 13.

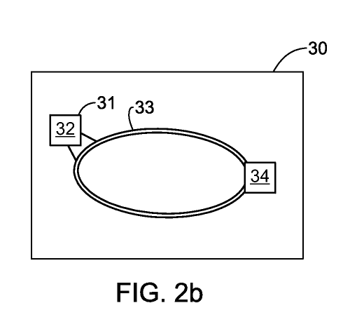

Referring to FIG. 2a, one embodiment of the present invention is the proximity card 20, comprising an integrated circuit 21, a capacitor 22, a first coil 23, a second coil 24, and a switch 25.

Referring to FIG. 2b, one embodiment of the present invention is the proximity card 30, comprising an integrated circuit 31, a capacitor 32, a first coil 33, and a switch 34.

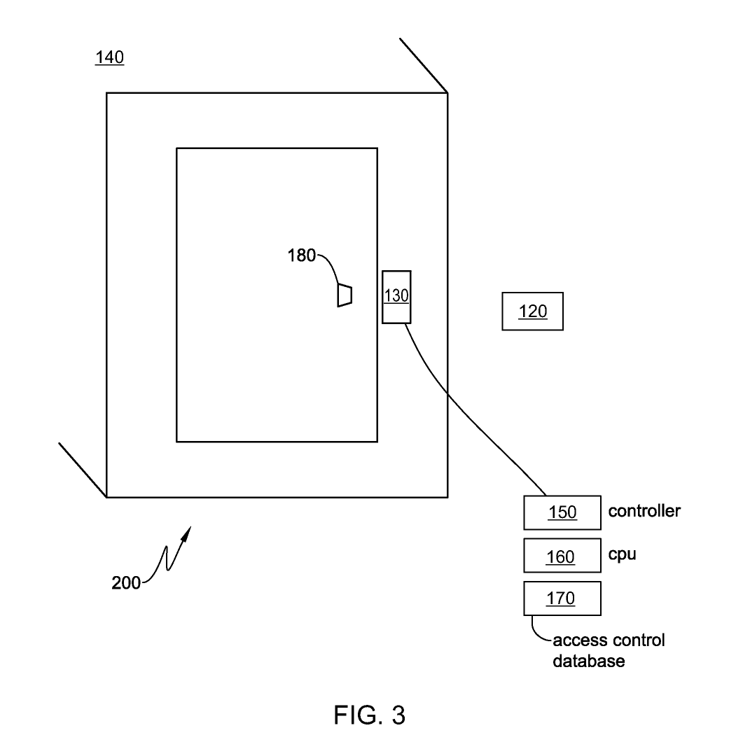

Referring to FIG. 3, proximity cards 120 are a popular means for emitting a request to an access control device 130 for authentication and access to a secured area or resource 140. Proximity cards are inexpensive, easy to use, and convenient for a user to carry. Typically, referring to FIG. 1, proximity cards contain an inductive circuit, including an integrated circuit 11, a capacitor 12, and a coil 13. These are all connected in parallel within the card.

When a proximity card is in range of a card reader 130, the card reader emits a field from an oscillator that excites the coil within the proximity card 120, and charges the capacitor within the proximity card, which activates the card's integrated circuit. Again referring to FIG. 1, once activated the integrated circuit 11 transmits a bit stream (card number) stored within the integrated circuit 11, via the coil 13, which acts as a transmitting antennae, to the card reader 130.

In one embodiment, the proximity card 120, which is also sometimes referred to as an identification card or as a “credential,” is approximately 2⅛″×3⅜″× 1/32″; which is generally the size of a conventional credit card, 8.5 cm by 5.5 cm. The proximity card 120 serves as a data source, or incorporates a data source. The data is communicated to a proximity card reader 130 and then to ultimately to a controller 150. The proximity card reader passes the detected bit stream from the proximity card to the processing hardware/software of the physical access control system where it is compared to the access control database for validation. The data to be transferred can include elements such as: an employee number, a unique personal identification number, or other stored data such as site codes.

One format for proximity cards is a 26-bit Wiegand format. In a 26-bit format, bit 1 is an even parity bit, bits 2-9 are site codes, bits 10-25 are the card number, and bit 26 is an odd parity bit. Wiegand has also been stretched to 34-bit and 56-bit, and many others. Any proximity card format could be used for the present invention, including, HID Corp 1000, FIPS75-200, Cardkey, and the like.

The frequency at which the oscillator in the card reader 130 excites the system is referred to as the carrier frequency. The frequency value in older devices is between about 110 to about 130 kilohertz. The frequency in newer contactless RFID cards, also known as contactless smartcards, is about 13.56 MHz. Proximity cards 120 have a distance over which they can communicate effectively with the card reader 130. This communication range is generally from 0 to about 80 mm.

The security system 200 has a controller or central processing unit 160 for controlling the security system 200. The CPU 160 accesses the access control database 170 that contains information related to access privileges and the information received from the input mechanism 120, such as a proximity card or smart card 120, is compared to the information in the access control database 170 to determine if the access control point 180 should be set to allow access. The access control point 180 could be an electronic latch, mechanical latch, lock, door, or a gate.

In conventional systems, input mechanism 120, such as a proximity card or smart card 120, would produce a signal that the controller 150 would compare to the database to determine if access should be granted. In the instant security system 200, the input mechanism 120 is capable of producing multiple signals that the controller 150 would consider proper to grant access. For example, certain additional signals would be used to notify an operator, or others, that a duress signal has been sent.

In slightly more advanced systems, the data from the proximity card or smart card 120 is first stored in the controller 150, and then is sent through communication link to a higher level computer system, not shown. This higher level computer system can make a variety of decisions, such as whether or not to ask for another reading, whether to operate an alarm, or check the time of request, and whether there is a user emergency.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. A duress detection system for assessing if a user seeking access to a secured area or resource is under duress, the system comprising:
a proximity card, wherein the proximity card comprises a first transponder and a switch;
a card reader configured to receive a duress signal from a transponder;
an access control point configured to control access to a secured area or resource; and
a notification mechanism capable of notifying a third party that the system has received a duress signal.

2. The duress detection system of claim 1, wherein the proximity card further comprises a second transponder.

3. The duress detection system of claim 1, wherein the switch is configured to be activated by the user's touch.

4. The duress detection system of claim 2, wherein the switch is configured to switch between the first transponder and the second transponder.

5. The duress detection system of claim 2, wherein the switch is configured to modify the signal from the first transponder to a duress signal.

6. The duress detection system of claim 3, wherein the switch comprises a thermistor.

7. The duress detection system of claim 3, wherein the switch comprises a piezoelectric sensor.

8. The duress detection system of claim 3, wherein the switch comprises an exposed electrode.

9. The duress detection system of claim 3, wherein the switch comprises a capacitive sensor.

10. The duress detection system of claim 4, wherein the switch comprises a thermistor.

11. The duress detection system of claim 4, wherein the switch comprises a piezoelectric sensor.

12. The duress detection system of claim 4, wherein the switch comprises an exposed electrode.

13. The duress detection system of claim 4, wherein the switch comprises a capacitive sensor.

14. The duress detection system of claim 1, wherein the notification mechanism sends an alarm.

15. The duress detection system of claim 1, wherein the notification mechanism sets a system flag.

16. The duress detection system of claim 15, wherein the notification mechanism sets the access control point to provide access in response to the duress signal.

17. The duress detection system of claim 15, wherein the notification mechanism sets the access control point to deny access in response to the duress signal.

18. The duress detection system of claim 1, wherein the duress signal comprises a reverse bit stream.

19. The duress detection system of claim 1, wherein the duress signal comprises a universal duress signal.

20. The duress detection system of claim 1, wherein the duress signal comprises a custom duress bit stream.

21. The duress detection system of claim 1, wherein the duress signal comprises a duress flag bit.

22. A method of detecting duress comprising:
capturing a signal from a proximity card near an access control point, wherein the proximity card comprises a first transponder and a switch;
comparing the signal from the proximity card to information in an access control database;
determining if duress is occurring; and
notifying a third party that a duress signal has been received.

23. The method of detecting duress of claim 22, wherein the step of notifying a third party comprises sending an alarm.

24. The method of detecting duress of claim 22, wherein the step of notifying a third party comprises setting a system flag.

25. The method of detecting duress of claim 24, further comprising the step of setting the access control point to provide access in response to the duress signal.

26. The method of detecting duress of claim 24, further comprising the step of setting the access control point to deny access in response to the duress signal.

27. The method of detecting duress of claim 22, wherein the duress signal from the proximity card comprises a reverse bit stream.

28. The method of detecting duress of claim 22, wherein the duress signal from the proximity card comprises a universal duress signal.

29. The method of detecting duress of claim 22, wherein the duress signal from the proximity card comprises a custom duress bit stream.

30. The method of detecting duress of claim 22, wherein the duress signal from the proximity card comprises a duress flag bit.

31. The method of detecting duress of claim 22, wherein the proximity card further comprises a second transponder.

32. The method of detecting duress of claim 31, wherein the duress signal from the proximity card originates from the second transponder.

33. The method of detecting duress of claim 22, wherein the switch is configured to be activated by the user's touch.

34. The method of detecting duress of claim 22, wherein the switch comprises a thermistor.

35. The method of detecting duress of claim 22, wherein the switch comprises a piezoelectric sensor.

36. The method of detecting duress of claim 22, wherein the switch comprises an exposed electrode.

37. The method of detecting duress of claim 22, wherein the switch comprises a capacitive sensor.

38. A duress-capable proximity card comprising,
a single transponder;
an integrated circuit, wherein the integrated circuit is attached to the single transponder thereby creating a circuit capable of transmitting a signal; and
a switch connected to the integrated circuit, wherein the switch is configured to modify the signal transmitted by the single transponder, thereby creating a second signal from a single transponder.

39. The duress-capable proximity card of claim 38, wherein the switch is configured to activate upon the user's touch.

40. The duress-capable proximity card of claim 39, wherein the switch comprises a thermistor.

41. The duress-capable proximity card of claim 39, wherein the switch comprises a piezoelectric sensor.

42. The duress-capable proximity card of claim 39, wherein the switch comprises an exposed electrode.

43. The duress-capable proximity card of claim 39, wherein the switch comprises a capacitive sensor.

44. The duress-capable proximity card of claim 38, wherein the second signal comprises a reverse bit stream.

45. The duress-capable proximity card of claim 38, wherein the second signal comprises a universal distress signal.

46. The duress-capable proximity card of claim 38, wherein the second signal comprises a custom duress bit stream.

47. The duress-capable proximity card of claim 38, wherein the second signal comprises a duress flag bit.

48. A duress-capable proximity card comprising,
a first transponder;
an integrated circuit, wherein the integrated circuit is attached to the first transponder thereby creating a first circuit capable of transmitting a first signal;
a second transponder adjacent to, but not connected to, the first circuit; and
a switch connected to the second transponder thereby creating a second circuit capable of transmitting a second signal.

49. The duress-capable proximity card of claim 48, wherein the switch is configured to activate upon the user's touch.

50. The duress-capable proximity card of claim 49, wherein the switch comprises a thermistor.

51. The duress-capable proximity card of claim 49, wherein the switch comprises a piezoelectric sensor.

52. The duress-capable proximity card of claim 49, wherein the switch comprises an exposed electrode.

53. The duress-capable proximity card of claim 49, wherein the switch comprises a capacitive sensor.

54. The duress-capable proximity card of claim 48, wherein the second signal comprises a reverse bit stream.

55. The duress-capable proximity card of claim 48, wherein the second signal comprises a universal distress signal.

56. The duress-capable proximity card of claim 48, wherein the second signal comprises a custom duress bit stream.

57. The duress-capable proximity card of claim 48, wherein the second signal comprises a duress flag bit.
